(19) United States
(12) Patent Application Publication
(10) Pub. No.: US 2015/0139323 A1
(43) Pub. Date: May 21, 2015

(54) METHOD OF DECODING IMAGES AND DEVICE USING SAME

(71) Applicant: ELECTRONICS AND TELECOMMUNICATIONS RESEARCH INSTITUTE, Daejeon (KR)

(72) Inventors: Ha Hyun Lee, Seoul (KR); Jung Won Kang, Daejeon (KR); Jin Ho Lee, Daejeon (KR); Jin Soo Choi, Daejeon (KR); Jin Woong Kim, Daejeon (KR)

(73) Assignee: ELECTRONICS AND TELECOMMUNICATIONS RESEARCH INSTITUTE, Daejeon (KR)

(21) Appl. No.: 14/402,268

(22) PCT Filed: Jul. 23, 2013
(86) PCT No.: PCT/KR2013/006596

§ 371 Date: Nov. 19, 2014

(30) Foreign Application Priority Data
Jul. 24, 2012 (KR) 10-2012-0080320
Oct. 8, 2012 (KR) 10-2012-0111062
Jul. 23, 2013 (KR) 10-2013-0086875

(51) Int. Cl. H04N 19/513; H04N 19/44

(52) U.S. Cl. CPC H04N 19/521; H04N 19/513; H04N 19/44
USPC 375/240.16

(57) ABSTRACT

Scalable video encoding uses interlayer texture prediction, interlayer motion information prediction, and interlayer residual signal prediction in order to remove redundancy from interlayer images. In order to increase the accuracy in interlayer prediction, the present invention may find a reference layer block on a location corresponding to the current target block and a block that is most similar to a sample of the current target block from images of a reference layer and use them as a prediction signal. Also, in interlayer prediction, a prediction signal obtained from an intra-layer image to which the current target block belongs and a prediction signal obtained from a reference layer image may be weighted and then used as a prediction signal.

### TECHNICAL FIELD

The present invention relates to the encoding and decoding processing of video and, more particularly, to a method and apparatus for encoding and decoding video, which support a plurality of layers within a bit stream.

### BACKGROUND ART

As broadcasting service having High Definition (HD) resolution is recently extended locally and worldwide, many users are being accustomed to video having high resolution and high picture quality. Accordingly, many institutes are giving impetus to the development of the next-generation image devices. Furthermore, in line with a growing interest in Ultra High Definition (UHD) having resolution 4 times higher than HDTV along with HDTV, there is a need for compression technology for video having higher resolution and higher picture quality.

In order to compress video, inter-prediction technology in which a value of a pixel included in a current picture is predicted from temporally anterior pictures or posterior pictures or both, intra-prediction technology in which a value of a pixel included in a current picture is predicted based on information about a pixel included in the current picture, and entropy encoding technology in which a short sign is assigned to a symbol having high frequency of appearance and a long sign is assigned to a symbol having low frequency of appearance can be used.

Video compression technology includes technology in which a constant network bandwidth is provided in an environment in which hardware limitedly operates without taking a flexible network environment into consideration. In order to compress video data applied to a network environment including a frequently changing bandwidth, new compression technology is necessary. To this end, a scalable video encoding/decoding method can be used.

### DISCLOSURE

### Technical Problem

In obtaining the prediction signal of a target block, a block having the most similar sample as the target block is searched from a picture of a reference layer, and the retrieved block or a block of the reference layer at a location corresponding to a location of the target block are used as a prediction signal.

Furthermore, in inter-layer prediction, the weighted sum of a prediction signal obtained from a picture in a layer to which a target block belongs and a prediction signal obtained from a picture in a reference layer is used as a prediction signal.

An object of the present invention is to improve encoding and decoding efficiency by minimizing a residual signal by increasing the accuracy of a prediction signal.

### Technical Solution

In accordance with an aspect of the present invention, a video decoding method supporting a plurality of layers includes receiving information about a prediction method of predicting a target block to be decoded and generating a prediction signal of the target block based on the received information, wherein the information includes predicting the target block using a restored lower layer.

Generating the prediction signal may include performing motion compensation in a direction of the lower layer.

The information may include a motion vector derived through motion estimation performed on a decoded picture of the lower layer in a coder.

Generating the prediction signal may include generating a restored value of a reference block, corresponding to the target block in the lower layer, as the prediction signal.

Generating the prediction signal may include performing motion compensation using a reference picture in the same layer as that of the target block and a restored picture in a layer to which the target block refers.

Generating the prediction signal may include calculating the weighted sum of a prediction signal obtained from a forward reference picture and a prediction signal obtained from a lower layer reference picture.

Generating the prediction signal may include calculating the weighted sum of a prediction signal obtained from a backward reference picture and a prediction signal obtained from a lower layer reference picture.

Generating the prediction signal may include calculating the weighted sum of a prediction signal obtained from a forward reference picture, a prediction signal obtained from a backward reference picture, and a prediction signal obtained from a lower layer reference picture.

Generating the prediction signal may include calculating the weighted sum of a prediction signal obtained from a reference sample included in a restored neighboring block neighboring the target block and a prediction signal obtained from a lower layer reference picture.

The information further may include information indicative of any one of an intra-frame prediction method, an inter-frame prediction method, a lower layer direction prediction method, and a prediction method using restored reference pictures in an identical layer and a lower layer in relation to the prediction method of prediction the target block.

In accordance with another aspect of the present invention, a video decoding apparatus supporting a plurality of layers includes a reception module configured to receive information about a prediction method of predicting a target block to be decoded and a prediction module configured to generate a prediction signal of the target block based on the received information, wherein the information includes predicting the target block using a restored lower layer.

### Advantageous Effects

In accordance with an embodiment of the present invention, there are provided a video decoding method and an apparatus using the same, wherein in obtaining the prediction signal of a target block, a block having the most similar sample as the target block is searched from a picture in a reference layer, and the retrieved block and a reference layer block at a location corresponding to a location of the target block are used as the prediction signal.

Furthermore, there are provided a video decoding method and an apparatus using the same, wherein in inter-layer prediction, the weighted sum of a prediction signal obtained from a picture within a layer to which a target block belongs and a prediction signal obtained from a reference layer picture are also used as a prediction signal.

Accordingly, encoding and decoding efficiency can be improved because a residual signal is minimized by increasing the accuracy of a prediction signal.

### DESCRIPTION OF DRAWINGS

FIG. 1 is a block diagram of a construction in accordance with an embodiment of a video encoding apparatus;

FIG. 2 is a block diagram of a construction in accordance with an embodiment of a video decoding apparatus;

FIG. 3 is a conceptual diagram schematically illustrating an embodiment of a scalable video coding structure using multiple layers to which the present invention can be applied;

FIG. 4 is a diagram showing an embodiment of intra-frame prediction modes;

FIG. 5 is a diagram showing an embodiment of neighboring blocks and neighbor samples which are used in an intra-frame prediction mode;

FIG. 6 is a conceptual diagram illustrating the generation of a prediction signal using a reference layer in accordance with an embodiment of the present invention;

FIG. 7 is a conceptual diagram illustrating the generation of a prediction signal using a reference layer in accordance with another embodiment of the present invention; and

FIG. 8 is a control flowchart illustrating a method of generating the prediction signal of a target block according to the present invention.

### MODE FOR INVENTION

Some exemplary embodiments of the present invention are described in detail with reference to the accompanying drawings. Furthermore, in describing the embodiments of this specification, a detailed description of the known functions and constitutions will be omitted if it is deemed to make the gist of the present invention unnecessarily vague.

In this specification, when it is said that one element is ‘connected’ or ‘coupled’ with the other element, it may mean that the one element may be directly connected or coupled with the other element or a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Furthermore, element units described in the embodiments of the present invention are independently shown to indicate difference and characteristic functions, and it does not mean that each of the element units is formed of a piece of separate hardware or a piece of software. That is, the element units are arranged and included, for convenience of description, and at least two of the element units may form one element unit or one element may be divided into a plurality of element units and the plurality of divided element units may perform functions. An embodiment into which the elements are integrated or embodiments from which some elements are separated are also included in the scope of the present invention, unless they depart from the essence of the present invention.

Furthermore, in the present invention, some elements are not essential elements for performing essential functions, but may be optional elements for improving only performance. The present invention may be implemented using only essential elements for implementing the essence of the present invention other than elements used to improve only performance, and a structure including only essential elements other than optional elements used to improve only performance is included in the scope of the present invention.

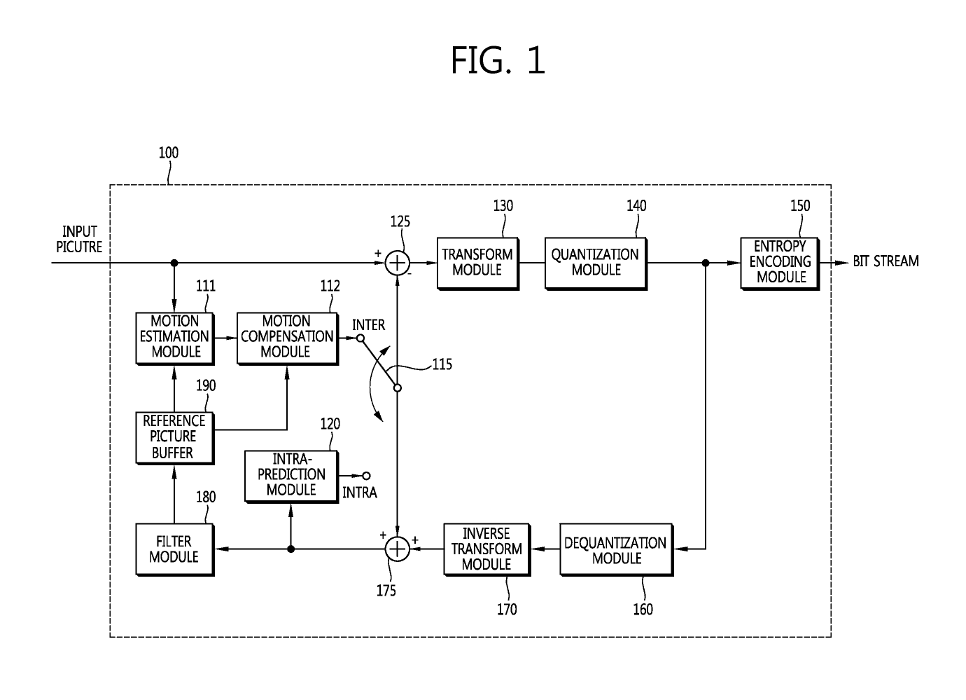

FIG. 1 is a block diagram of a construction in accordance with an embodiment of a video encoding apparatus. A scalable video encoding/decoding method or apparatus can be implemented by extending a common video encoding/decoding method or apparatus that do not provide scalability. The block diagram of FIG. 1 illustrates an embodiment of a video encoding apparatus that may become a basis for the scalable video encoding apparatus.

Referring to FIG. 1, the video encoding apparatus 100 includes a motion estimation module 111, a motion compensation module 112, an intra-prediction module 120, a switch 115, a subtractor 125, a transform module 130, a quantization module 140, an entropy encoding module 150, a dequantization module 160, an inverse transform module 170, an adder 175, a filter module 180, and a reference picture buffer 190.

The video encoding apparatus 100 can perform encoding on an input picture in an intra-mode or an inter-mode and output a bit stream. In this specification, intra-prediction means intra-frame prediction, and inter-prediction means inter-frame prediction. In the intra-mode, the switch 115 can switch to intra mode. In the inter-mode, the switch 115 can switch to the inter-mode. The video encoding apparatus 100 can generate a prediction block for the input block of an input picture and then encode a difference between the input block and the prediction block.

In the intra-mode, the intra-prediction module 120 can generate the prediction block by performing spatial prediction based on values of the pixels of already coded blocks that neighbor a current block.

In the inter-mode, the motion estimation module 111 can obtain a motion vector by searching a reference picture, stored in the reference picture buffer 190, for a region that is most well matched with the input block in a motion estimation process. The motion compensation module 112 can generate the prediction block by performing motion compensation based on the motion vector and the reference picture stored in the reference picture buffer 190.

The subtractor 125 can generate a residual block based on the residual between the input block and the generated prediction block. The transform module 130 can perform transform on the residual block and output a transform coefficient according to the transformed block. Furthermore, the quantization module 140 can output a quantized coefficient by quantizing the received transform coefficient based on at least one of a quantization parameter and a quantization matrix.

The entropy encoding module 150 can perform entropy encoding on a symbol according to a probability distribution based on values calculated by the quantization module 140 or encoding parameter values calculated in a encoding process and output a bit stream. The entropy encoding method is a method of receiving a symbol having various values and representing the symbol in the form of a string of a binary number that can be decoded while removing statistical redundancy.

Here, a symbol means a target encoding/decoding syntax element, a coding parameter, or a value of a residual signal. The coding parameter is a parameter necessary for encoding and decoding. The coding parameter can include information, such as a syntax element that is coded by a encoder and then transferred to a decoder, and information that can be inferred in encoding or decoding process. The coding parameter means information that is necessary to code or decode video. The coding parameter can include, for example, an intra/inter-prediction mode, a motion vector, a reference picture index, an coding block pattern, the existence or non-existence of a residual signal, a transform coefficient, a quantized transform coefficient, a quantization parameter, a block size, and a value or statistics, such as block partition information. Furthermore, the residual signal can mean a difference between the original signal and a prediction signal. Furthermore, the residual signal may mean a signal having a form in which a difference between the original signal and a prediction signal is transformed or a signal having a form in which a difference between the original signal and a prediction signal is transformed and quantized. The residual signal can also be called a residual block in a block unit.

If entropy encoding is used, the size of a bit stream for a symbol to be coded can be reduced because the symbol is represented by allocating a small number of bits to a symbol having a high incidence and a large number of bits to a symbol having a low incidence. Accordingly, compression performance for video encoding can be improved through entropy encoding.

For the entropy encoding, encoding methods, such as exponential Golomb, Context-Adaptive Binary Arithmetic Coding (CABAC), and Context-Adaptive Binary Arithmetic Coding (CABAC), can be used. For example, the entropy encoding module 150 can store a table for performing entropy encoding, such as a Variable Length Coding/Code (VLC) table. The entropy encoding module 150 can perform entropy encoding using the stored VLC table. Furthermore, the entropy encoding module 150 may derive a method of binarizing a target symbol and a probability model for a target symbol/bin and perform entropy encoding using the derived binarization method or probability model.

The quantized coefficient is dequantized by the dequantization module 160 and then inversely transformed by the inverse transform module 170. The dequantized and inversely transformed coefficient is added to the prediction block through the adder 175, thereby generating a restored block.

The restored block experiences the filter module 180. The filter module 180 can apply one or more of a deblocking filter, a Sample Adaptive Offset (SAO), and an Adaptive Loop Filter (ALF) to the restored block or the restored picture. The restored block passing through the filter module 180 can be stored in the reference picture buffer 190.

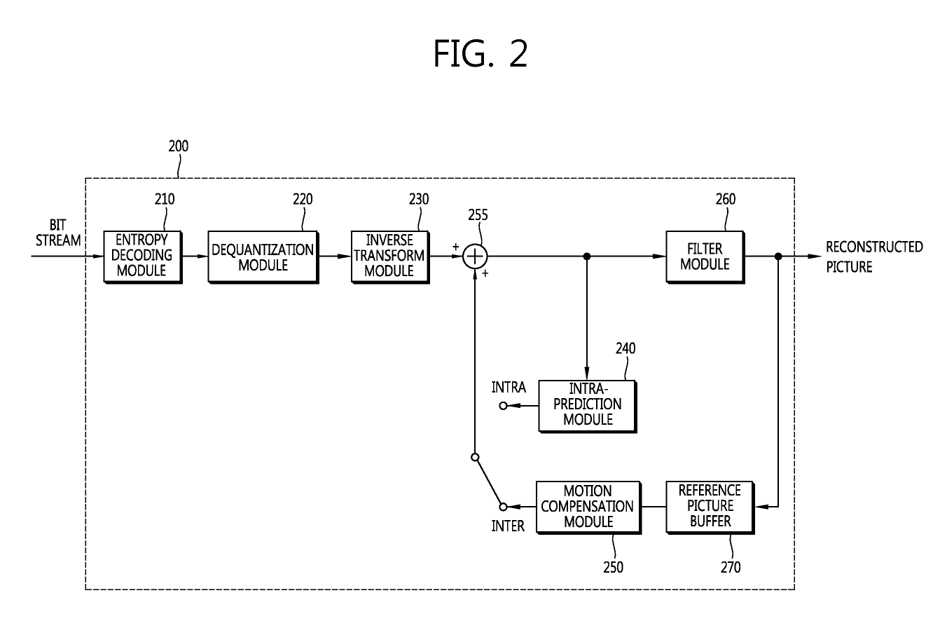

FIG. 2 is a block diagram of a construction in accordance with an embodiment of a video decoding apparatus. As described with reference to FIG. 1, a scalable video encoding/decoding method or apparatus can be implemented by extending a common video encoding/decoding method or apparatus that do not provide scalability. The block diagram of FIG. 2 illustrates an embodiment of a video decoding apparatus that may become a basis for a scalable video decoding apparatus.

Referring to FIG. 2, the video decoding apparatus 200 includes an entropy decoding module 210, a dequantization module 220, an inverse transform module 230, an intra-prediction module 240, a motion compensation module 250, a filter module 260, and a reference picture buffer 270.

The video decoding apparatus 200 can receive a bit stream outputted from the encoder, perform decoding on the bit stream in the intra-mode or the inter-mode, and output a restored picture, that is, a restored picture. In the intra-mode, a switch can switch to intra-mode. In the inter-mode, the switch can switch to the inter-mode. The video decoding apparatus 200 can obtain a restored residual block from the received bit stream, generate a prediction block, and then generate a reconstructed block, that is, a restored block, by adding the restored residual block to the prediction block.

The entropy decoding module 210 can generate symbols including a symbol having a quantized coefficient form by performing entropy decoding on the received bit stream according to a probability distribution. The entropy decoding method is a method of receiving a string of a binary number and generating symbols. The entropy decoding method is similar to the aforementioned entropy encoding method.

The quantized coefficient is dequantized by the dequantization module 220 and then inversely transformed by the inverse transform module 230. As a result of the dequantization/inverse transform of the quantized coefficient, a residual block can be generated.

In the intra-mode, the intra-prediction module 240 can generate a prediction block by performing spatial prediction based on pixel values of already decoded blocks neighboring the current block. In the inter-mode, the motion compensation module 250 can generate a prediction block by performing motion compensation based on a motion vector and a reference picture stored in the reference picture buffer 270.

The restored residual block and the prediction block are added together by an adder 255. The added block experiences the filter module 260. The filter module 260 can apply at least one of a deblocking filter, an SAO, and an ALF to the restored block or the restored picture. The filter module 260 outputs a restored picture, that is, a restored picture. The restored picture can be stored in the reference picture buffer 270 and can be used for inter-frame prediction.

From among the entropy decoding module 210, the dequantization module 220, the inverse transform module 230, the intra-prediction module 240, the motion compensation module 250, the filter module 260, and the reference picture buffer 270 included in the video decoding apparatus 200, elements directly related to video decoding, for example, the entropy decoding module 210, the dequantization module 220, the inverse transform module 230, the intra-prediction module 240, the motion compensation module 250, and the filter module 260 can be collectively represented as a decoding module differently from other elements.

The video decoding apparatus 200 can further include a parsing module (not shown) for parsing information related to encoded video that is included in a bit stream. The parsing module may include the entropy decoding module 210, or the parsing module may be included in the entropy decoding module 210. The parsing module may be implemented as one of the elements of the decoding module.

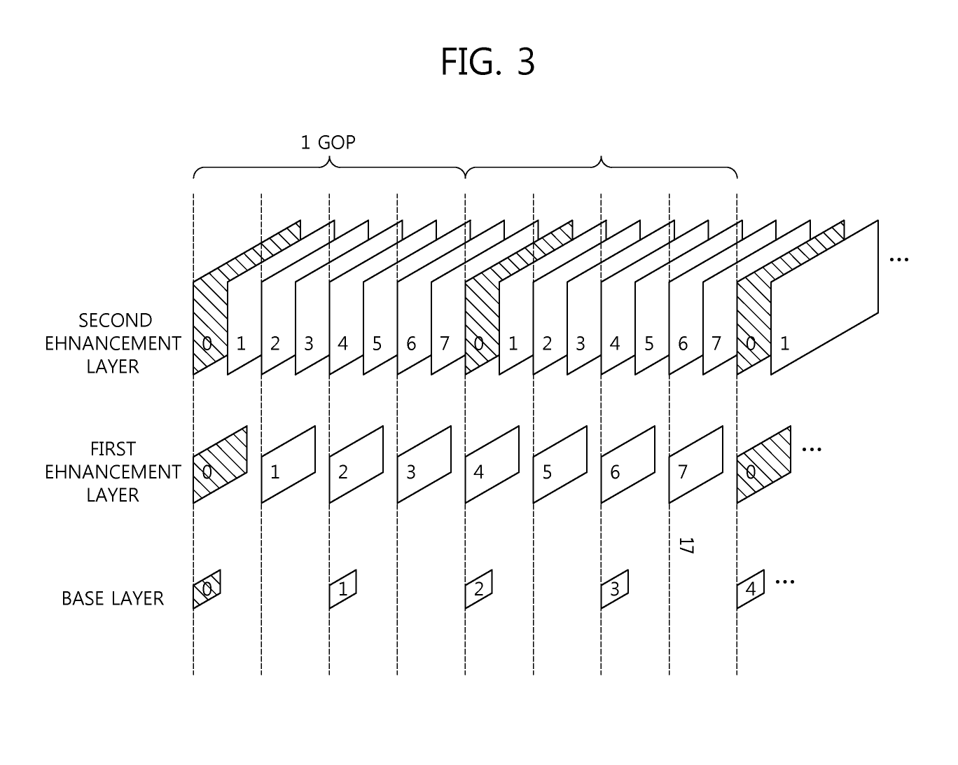

FIG. 3 is a conceptual diagram schematically illustrating an embodiment of a scalable video encoding structure using multiple layers to which the present invention can be applied. In FIG. 3, a Group of Picture (GOP) refers to a picture group, that is, a group of pictures.

A transport medium is necessary to send video data, and a transport medium has different performance depending on various network environments. A scalable video encoding method can be provided in order to be applied to various transport media or network environments.

The scalable video encoding method is a method of increasing encoding/decoding performance by removing inter-layer redundancy based on texture information between layers, motion information, and a residual signal. The scalable video encoding method can provide various scalabilities from spatial, temporal, and picture quality viewpoints depending on surrounding conditions, such as a transfer bit rate, a transfer error rate, and system resources.

Scalable video encoding can be performed using a multiple layer structure so that a bit stream applicable to various network conditions can be provided. For example, a scalable video encoding structure can include a base layer for compressing and processing video data using a common video encoding method and can include an enhancement layer for compressing and processing video data using both information about the encoding of a base layer and a common video encoding method.

Here, the layer means video and a set of bit streams that are classified on the basis of spatial (e.g., a picture size), temporal (e.g., encoding order, picture output order, and a frame rate), picture quality, and complexity. Furthermore, the base layer can mean a lower layer or a reference layer, and the enhancement layer can mean a higher layer. Furthermore, a plurality of layers may have dependency.

Referring to FIG. 3, for example, a base layer can be defined by Standard Definition (SD), a frame rate of 15 Hz, and a bit rate of 1 Mbps. A first enhancement layer can be defined by High Definition (HD), a frame rate of 30 Hz, and a bit rate of 3.9 Mbps. A second enhancement layer can be defined by 4K-Ultra High Definition (UHD), a frame rate of 60 Hz, and a bit rate of 27.2 Mbps. A format, a frame rate, and a bit rate are only embodiments and can be differently determined, if necessary. Furthermore, the number of layers used is not limited to the present embodiment and can be differently determined, if necessary.

For example, if a transport bandwidth is 4 Mbps, the frame rate of the first enhancement layer HD can be reduced in order to perform transmission with 15 Hz or lower. A scalable video encoding method can provide temporal, spatial, and picture quality scalabilities according to the aforementioned method in the embodiment of FIG. 3.

Hereinafter, scalable video encoding has the same meaning as scalable video encoding from a viewpoint of encoding and has the same meaning as video decoding from a viewpoint of decoding.

Furthermore, in a method of encoding and decoding scalable video, that is, video using a multiple layer structure, a method of generating the prediction block of a block that is the subject of encoding and decoding of a higher layer (hereinafter referred to as a current block or a target block), that is, a prediction signal, is described below. A lower layer to which reference is made by a higher layer is represented as a reference layer.

First, the prediction signal of a target block can be generated through common intra-frame prediction.

In intra-frame prediction, a prediction mode can be basically divided into a directional mode and a non-directional mode depending on a direction in which reference pixels used to predict a pixel value are located and a prediction method. The prediction mode can be specified using a predetermined angle and a mode number, for convenience of description.

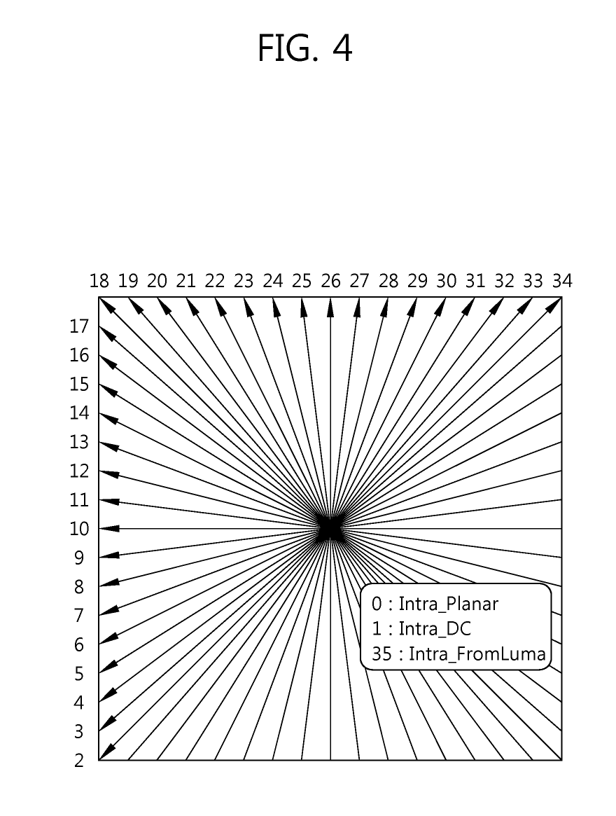

FIG. 4 is a diagram showing an embodiment of intra-frame prediction modes.

The number of intra-frame prediction modes can be fixed to a predetermined number irrespective of the size of a prediction block and can be fixed to 35 as in FIG. 4.

Referring to FIG. 4, the intra-frame prediction modes can include 33 directional prediction modes and 2 non-directional modes. The directional modes include modes from the No. 2 intra-frame prediction mode in the lower left direction to the No. 34 intra-frame prediction mode in a clockwise direction.

The number of intra-frame prediction modes may differ depending on whether a color component is a lum a signal or a chrom a signal. Furthermore, ‘Intra_FromLuma’ in FIG. 4 can mean a specific mode in which a chrom a signal is estimated from a luma signal.

A planar mode ‘Intra_Planar’ and a DC mode ‘Intra_DC’, that is, the non-directional modes, can be allocated to the Nos. 0 and 1 intra-frame prediction mode, respectively.

In the DC mode, one fixed value, for example, an average value of surrounding restored pixel values is used as a prediction value. In the planar mode, vertical interpolation and horizontal interpolation are performed based on pixel values that vertically neighbor a current block and pixel values that horizontally neighbor the current block, and an average value of the pixel values is used as a prediction value.

A directional mode ‘Intra_Angular’ indicates a corresponding direction at an angle between a current pixel and a reference pixel located in a predetermined direction and can include a horizontal mode and a vertical mode. In the vertical mode, a pixel value that vertically neighbors a current block can be used as a prediction value of the current block. In the horizontal mode, a pixel value that horizontally neighbors a current block can be used as a prediction value of the current block.

The size of a prediction block having a prediction value or a prediction signal can be a square, such as 4×4, 8×8, 16×16, 32×32, or 64×64, or a rectangle, such as 2×8, 4×8, 2×16, 4×16, or 8×16. Furthermore, the size of a prediction block can be any one of a Coding Block (CB), a Prediction Block (PB), and a Transform Block (TB).

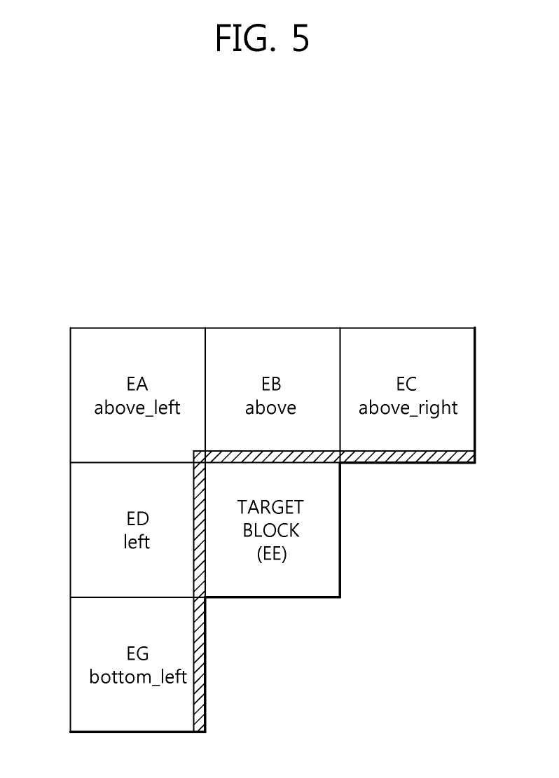

Intra-frame encoding/decoding can be performed based on sample values or encoding parameters that are included in neighboring restored blocks. FIG. 5 is a diagram showing an embodiment of neighboring blocks and neighbor samples which are used in an intra-frame prediction mode.

Referring to FIG. 5, neighboring restored blocks can include, for example, blocks EA, EB, EC, ED, and EG according to encoding/decoding order, and sample values corresponding to ‘above’, ‘above_left’, ‘above_right’, ‘left’, and ‘bottom_left’ can be reference samples used for the intra-frame prediction of a target block. Furthermore, a coding parameter can be at least one of a coding mode (intra-frame or inter-frame), an intra-frame prediction mode, an inter-frame prediction mode, a block size, a Quantization Parameter (QP), and a Coded Block Flag (CBF).

In FIG. 5, each block can be partitioned into smaller blocks. Even in this case, intra-frame encoding/decoding can be performed based on sample values corresponding to the respective partitioned blocks or a encoding parameter.

Furthermore, the prediction signal of the target block can be generated through inter-frame prediction.

In inter-frame prediction, a current block can be predicted based on a reference picture using at least one of a picture that is anterior or posterior to the current picture as the reference picture. A picture used to predict a current block is called a reference picture or a reference frame.

A region within a reference picture can be indicated by a reference picture index ‘refldx’ indicating the reference picture, a motion vector, or the like.

In inter-frame prediction, a reference picture and a reference block, corresponding to a current block within the reference picture, can be selected, and a prediction block for the current block can be generated.

In inter-frame prediction, the encoder and the decoder can derive motion information about a current block and perform inter-frame prediction or motion compensation or both based on the derived motion information. Here, the encoder and the decoder can use motion information about a collocated (hereinafter referred to as ‘Col’) block corresponding to the current block within a restored neighboring block or an already restored and Col picture or both, thereby being capable of improving encoding/decoding efficiency.

Here, the restored neighboring block is a block that has already been coded and/or decoded and placed within a restored current picture. The restored neighboring block can include a block that neighbors a current block or a block located at the outer corner of the current block or both. Furthermore, the encoder and the decoder can determine a specific relative location on the basis of a block at a location spatially corresponding to a current block within a Col picture and derive a Col block on the basis of the determined specific relative location (i.e., a location inside and/or outside block at the location spatially corresponding to the current block). Here, for example, the Col picture can correspond to one of reference pictures included in a reference picture list.

In inter-frame prediction, a prediction block can be generated so that a residual signal with a current block is minimized and the size of a motion vector is also minimized.

Meanwhile, a method of deriving motion information may vary depending on a prediction mode of a current block. Prediction modes applied to inter-prediction can include an Advanced Motion Vector Predictor (AMVP) mode, a merge mode, etc.

For example, if the AMVP mode is applied to inter-prediction, the encoder and the decoder can generate a prediction motion vector candidate list based on a motion vector of a restored neighboring block or a motion vector of a Col block or both. That is, the motion vector of the restored neighboring block or the motion vector of the Col block or both can be used as prediction motion vector candidates. The encoder can send a prediction motion vector index indicative of an optimal prediction motion vector, selected from prediction motion vector candidates included in the prediction motion vector candidate list, to the decoder. Here, the decoder can select the prediction motion vector of a current block from the prediction motion vector candidates, included in the prediction motion vector candidate list, based on the prediction motion vector index.

The encoder can obtain a Motion Vector Difference (MVD) between the motion vector and prediction motion vector of the current block, code the MVD, and send the coded MVD to the decoder. Here, the decoder can decode the received MVD and derive the motion vector of the current block through the sum of the decoded MVD and the prediction motion vector.

Furthermore, the encoder can send a reference picture index indicative of a reference picture to the decoder.

The decoder can predict the motion vector of the current block based on pieces of motion information about neighboring blocks and derive the motion vector of the current block using a residual received from the encoder. The decoder can generate a prediction block for the current block based on the derived motion vector and information about the reference picture index received from the encoder.

For another example, if the merge mode is applied to inter-prediction, the encoder and the decoder can generate a merge candidate list based on motion information about a restored neighboring block or motion information about a Col block or both. That is, if motion information about a restored neighboring block or a Col block or both is present, the encoder and the decoder can use the motion information as a merge candidate for a current block.

The encoder can select a merge candidate capable of providing optimal encoding efficiency as motion information about a current block, from merge candidates included in a merge candidate list. Here, a merge index indicative of the selected merge candidate can be included in a bit stream and transmitted to the decoder. The decoder can select one of the merge candidates, included in the merge candidate list, based on the received merge index and determine the selected merge candidate as motion information about the current block. Accordingly, if the merge mode is applied to inter-prediction, motion information about a restored neighboring block or a Col block or both can be used as motion information about a current block without change. The decoder can restore the current block by adding the prediction block and a residual received from the encoder.

In the AMVP and merge modes, in order to derive motion information about a current block, motion information about a restored neighboring block or motion information about a Col block or both can be used.

In a skip mode that is one of modes used in inter-frame prediction, information about a neighboring block can be used in a current block without change. Accordingly, in the skip mode, the encoder does not send syntax information, such as a residual, to the decoder other than information indicating that motion information about what block will be used as motion information about a current block.

The encoder and the decoder can generate the prediction block for the current block by performing motion compensation on the current block based on the derived motion information. Here, the prediction block can mean a motion-compensated block that has been generated by performing motion compensation on the current block. Furthermore, a plurality of motion-compensated blocks can form one motion-compensated image.

The decoder can derive motion information necessary for the inter-prediction of the current block, for example, information about a motion vector and a reference picture index by checking a skip flag and a merge flag received from the encoder.

A processing unit on which prediction is performed can differ from a processing unit on which a prediction method and detailed contents are determined. For example, a prediction mode may be determined in a PU unit, and prediction may be performed in a TU unit. For another example, a prediction mode may be determined in a PU unit, and intra-frame prediction may be performed in a TU unit.

In video supporting multiple layers, the prediction signal of a target block in a higher layer can be generated using a method using a lower layer in which the target block can be referred to, that is, the restored picture of a reference layer in addition to the aforementioned intra-frame prediction method and the aforementioned inter-frame prediction method.

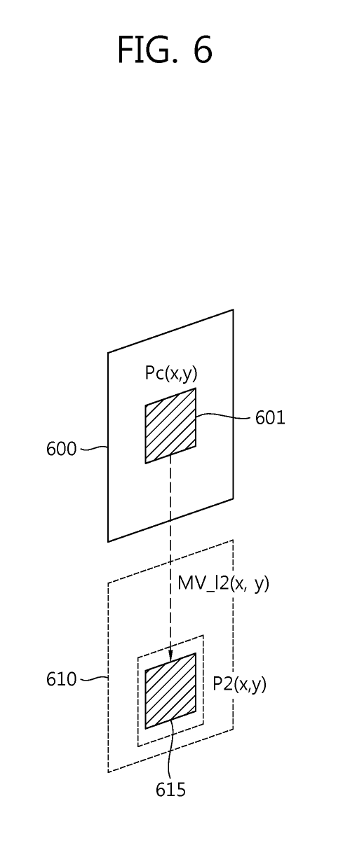

FIG. 6 is a conceptual diagram illustrating the generation of a prediction signal using a reference layer in accordance with an embodiment of the present invention.

As shown in FIG. 6, assuming that the prediction signal of a target block 601 that will be coded or decoded in a higher layer 600, that is, a sample value of a target block, is Pc[x,y] and a restored value of the restored picture of a reference layer 610 is P2[x,y], Pc[x,y] can be generated based on P2[x,y].

After being restored, the reference layer 610 can be subject to up-sampling depending on resolution of the higher layer 600, and P2[x,y] can be an up-sampled sample value.

Assuming that a location of the target block 601 corresponds to a location of a reference block 615 in the reference layer 610, P2[x,y] can be a restored sample value of the reference block 615.

A method of obtaining the prediction signal from the restored reference layer 610 is to apply an inter-frame prediction method with reference to the restored reference layer 610 as in FIG. 6. That is, the encoder performs motion estimation and motion compensation on the reference layer 610 and uses a prediction signal, generated as a result of the motion estimation and motion compensation, as the prediction signal of a target block to be coded. The decoder can perform motion compensation based on a motion vector that has been derived by the motion estimation performed on a decoded picture of the lower layer in the encoder.

The encoder can code obtained motion information and send the coded motion information to the decoder. The decoder can decode the received motion information and perform inter-frame prediction with reference to the reference layer 610. The motion information can be a reference picture index ‘refldx’ indicative of a reference picture and a motion vector (MV).

Meanwhile, if the reference layer 610 is used in inter-frame prediction, the reference picture index ‘refldx’ indicating the reference picture, from among pieces of coded motion information, may not be transmitted.

The encoder can predict a motion vector of the target block based on pieces of motion information about neighboring blocks that neighbor the target block 601, code a difference value between the motion vector of the target block and the predicted motion vector, and send the coded difference value to the decoder as a motion vector MV_{—}2[x,y]. Here, the neighboring blocks used for the motion estimation of the target block 601 can be blocks that have been coded from the restored picture of the reference layer. That is, the encoder can derive the motion vector of the target block 601 based on pieces of motion information about the neighboring blocks that have been coded from the restored picture of the reference layer, from among neighboring blocks. In this case, the encoder can code information indicating that motion information about what block is used and send the coded information to the decoder.

If a block coded from the restored picture of the reference layer is not present in neighboring blocks, (0,0) can be used as a motion vector prediction candidate.

In video supporting a plurality of layers within a bit stream, when obtaining the prediction signal of a target block through inter-layer prediction, prediction can be performed using only a reference layer block at a location corresponding to a location of the target block. In general, an up-sampling process is performed on a reference layer because pictures between layers can have different sizes. If the up-sampling process is performed, pixels between inter-layer pictures can have different phases. Thus, if only a reference layer block at a location corresponding to a location of a target block is used, there is a problem in that a prediction error component due to a difference between the phases cannot be reduced. In order to overcome this problem, in the present embodiment, a prediction value closer to a target block to be coded and decoded can be obtained by performing motion estimation on a reference layer as well as by using only a block corresponding to the reference layer.

Meanwhile, the encoder can use a restored sample value of the reference block 615 as the prediction signal of the target block 601 in addition to the method of obtaining the prediction signal from the restored picture of the reference layer through motion estimation. This can be represented as in the following equation.

Pc[x,y]=P2[x,y] <Equation 1>

The encoder may generate the prediction signal through motion estimation in which the restored reference layer 610 is referred to or may use a restored sample value of the reference block 615, corresponding to the target block 601, as the prediction signal without change. If the prediction signal is generated using the reference layer, the encoder can code information indicating that what method is used and send the coded information to the decoder.

In accordance with another embodiment, when encoding and decoding a target block, the prediction signal of a target block to be coded can be obtained using both a picture within a layer to which the target block belongs and the restored picture of the reference layer.

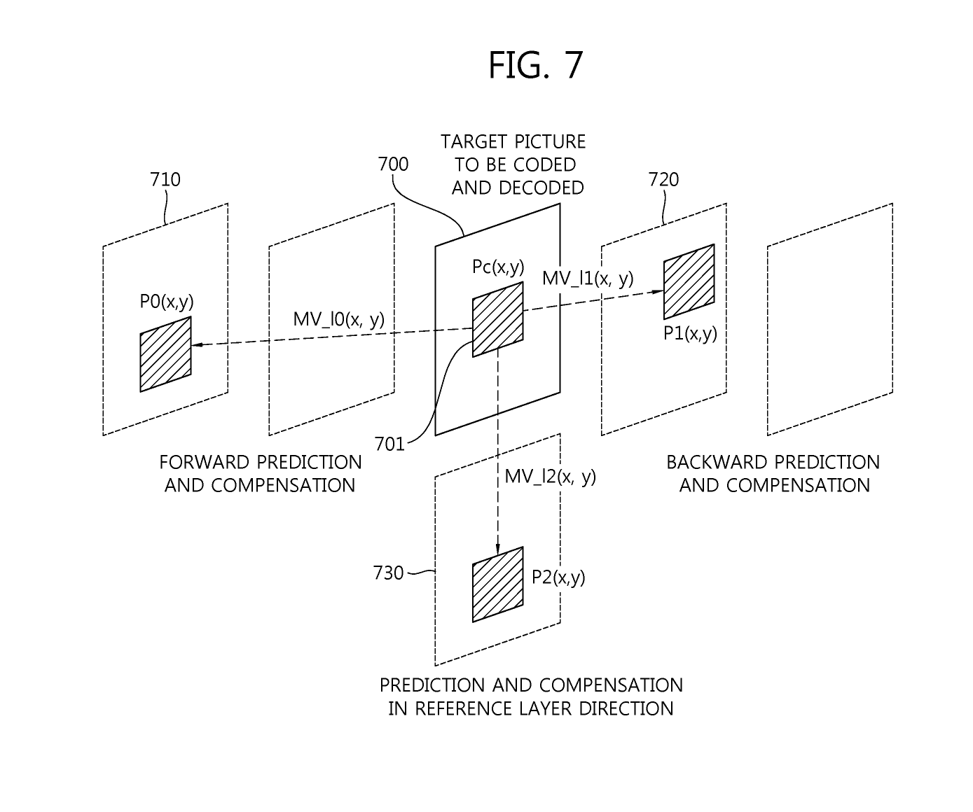

FIG. 7 is a conceptual diagram illustrating the generation of a prediction signal using a reference layer in accordance with another embodiment of the present invention.

Referring to FIG. 7, a target block 701 to be coded and decoded in a current picture 700 can refer to a forward reference picture 710 or a backward reference picture 720 that belongs to the same layer or may refer to a lower layer reference picture 730 that belongs to a different layer. The forward reference picture 710, the backward reference picture 720, and the lower layer reference picture 730 can be restored pictures.

Assuming that the prediction signal of the target block 701 is Pc[x,y], Pc[x,y] can be generated using various methods depending on a picture to which the target block 701 can refer. The prediction signal Pc[x,y] can be generated based on an average value or a weighted sum, that is, a weight average, of predicted values generated from pictures to which the target block 701 can refer.

(Method 1)

If a prediction signal predicted from the forward reference picture 710 is P0[x,y] and a prediction signal predicted from the lower layer reference picture 730 is P2[x,y], the prediction signal Pc[x,y] can be obtained based on the weighted sum of the prediction signals P0[x,y] and P2[x,y]. An example of the weighted sum is represented in Equation 2.

Pc[x,y]={(a)P0[x,y]+(b)*P2[x,y]}/2 <Equation 2>

In Equation 2, (a) and (b) are parameters for the weighted sum, and the parameters (a) and (b) may have the same value or different values. The parameter (a) may be greater than the parameter (b), or the parameter (b) may be greater than the parameter (a). The parameters (a) and (b) may be set so that an integer operation or may be set irrespective of an integer operation. The parameters (a) and (b) may be integers or rational numbers.

The encoder may add a specific offset value so that the prediction signal Pc[x,y] becomes an integer.

The encoder can send a motion vector MV_I0[x,y], obtained through motion estimation with reference to the forward reference picture 710, and a motion vector MV_I2[x,y], obtained through motion estimation with reference to the lower layer reference picture 730, to the decoder.

If a reference block at a location corresponding to a location of a target block is obtained from are stored picture in a lower layer and a restored sample value of the reference block is used as the prediction signal of a target block, the encoder can omit the transmission of motion information about the picture of the lower layer.

(Method 2)

Assuming that a prediction signal obtained from the backward reference picture 720 is P1 [x,y], the prediction signal Pc[x,y] can be generated based on the weighted sum of the prediction signal P1[x,y] and the prediction signal P2[x,y] obtained from the lower layer reference picture 730. An example of the weighted sum is represented in Equation 3.

Pc[x,y]={(a)*P1[x,y]+(b)*P2[x,y]}/2 <Equation 3>

In Equation 3, (a) and (b) are parameters for the weighted sum, and the parameters (a) and (b) may have the same value or different values. The parameter (a) may be greater than the parameter (b), or the parameter (b) may be greater than the parameter (a). The parameters (a) and (b) may be set so that an integer operation or may be set irrespective of an integer operation. The parameters (a) and (b) may be integers or rational numbers.

The encoder may add a specific offset value so that the prediction signal Pc[x,y] becomes an integer.

The encoder can send a motion vector MV_I1[x,y], obtained through motion estimation with reference to the backward reference picture 720, and the motion vector MV_I2[x,y], obtained through motion estimation with reference to the lower layer reference picture 730, to the decoder.

Even in this case, if a reference block at a location corresponding to a location of a target block is obtained from a restored picture in a lower layer and a restored sample value of the reference block is used as the prediction signal of a target block, the encoder can omit the transmission of motion information about the picture of the lower layer.

(Method 3)

The prediction signal Pc[x,y] can be derived from the weighted sum of the prediction signal P0[x,y] obtained from the forward reference picture 710, the prediction signal P1[x,y] obtained from the backward reference picture 720, and the prediction signal P2[x,y] obtained from the lower layer reference picture 730. An example of the weighted sum is represented in Equation 4.

Pc(x,y)={(a)*P0(x,y)+(b)*P1(x,y)+(c)*P2(x,y)}/3 (Equation 4)

In Equation 4, (a), (b), and (c) are parameters for the weighted sum, and the parameters (a), (b), and (c) may have the same value or different values. The parameters (a), (b), and (c) may be set so that an integer operation or may be set irrespective of an integer operation. The parameters (a), (b), and (c) may be integers or rational numbers.

The encoder may add a specific offset value so that the prediction signal Pc[x,y] becomes an integer.

The encoder can send the motion vectors MV_I0[x,y] and MV_I1[x,y], obtained through motion estimation with reference to the forward reference picture 710 and the backward reference picture 720, and the motion vector MV_I2[x,y], obtained through motion estimation with reference to the lower layer reference picture 730, to the decoder.

If a reference block at a location corresponding to a location of a target block is obtained from a restored picture in a lower layer and a restored sample value of the reference block is used as the prediction signal of a target block, for example, when the parameters (a) and (b) are 0, the encoder can omit the transmission of motion information about the picture of the lower layer.

(Method 4)

The prediction signal Pc[x,y] can be generated from the weighted sum of the prediction signal P0[x,y] obtained from a reference sample that is included in a restored neighboring block neighboring a target block to be coded and the prediction signal P2[x,y] obtained from the lower layer reference picture 730. An example of the weighted sum is represented in Equation 5.

Pc[x,y]={(a)*P0[x,y]+(b)*P2[x,y]}/2 <Equation 5>

In Equation 5, (a) and (b) are parameters for the weighted sum, and the parameters (a) and (b) may have the same value or different values. The parameter (a) may be greater than the parameter (b), or the parameter (b) may be greater than the parameter (a). The parameters (a) and (b) may be set so that an integer operation or may be set irrespective of an integer operation. The parameters (a) and (b) may be integers or rational numbers.

The encoder may add a specific offset value so that the prediction signal Pc[x,y] becomes an integer.

The encoder can code an intra-frame prediction mode obtained from a neighboring restored reference sample and the motion information MV_I2[x,y] obtained through motion estimation with reference to the lower layer reference picture 730 and send them to the decoder.

Meanwhile, even in this case, if a restored sample value of a block at a location corresponding to a location of a target block from a restored picture in a lower layer is used as a prediction signal irrespective of the prediction signal P0[x,y] obtained from a reference sample included in a neighboring block, the transmission of motion information for the lower layer picture can be omitted.

Coefficients for the weights (a), (b), and (c) used in Equations 2 to 5 can be signaled using coding parameters. The coding parameter can include information, such as a syntax element that is coded by the encoder and transmitted to the decoder, and information that can be inferred in an encoding or decoding process. The information means information necessary to code or decode a picture.

The coefficient for (a), (b), or (c) for the weighted sum can be included in a Video Parameter Set (VPS), a Sequence Parameter Set (SPS), a Picture Parameter Set (PPS), an Adaptation Parameter Set (APS), or a slice header, coded, and transmitted to the decoder.

Alternatively, the coefficient for (a), (b), or (c) for the weighted sum may be set according to a rule that is determined so that the encoder and the decoder use the same coefficient value.

In encoding motion information about a lower layer picture, the transmission of a reference picture index ‘refldx’ indicative of a reference picture, from among pieces of motion information, can be omitted.

The encoder can predict a motion vector of a target block based on pieces of motion information about neighboring blocks that neighbor the target block, code a difference value between a motion vector of the target block and the predicted motion vector, and send the coded difference value as the motion vector MV_{—}2[x,y]. Here, the neighboring blocks used for the motion estimation of the target block can be blocks that have been coded as a restored picture in a lower layer. That is, the encoder can derive the motion vector of the target block based on pieces of motion information about neighboring blocks that have been coded as the restored picture of the lower layer, from among the neighboring blocks. In this case, the encoder can code information indicating that motion information about what block is used and send the coded information to the decoder.

If a block coded as the restored picture of a lower layer is not present in the neighboring blocks, (0,0) can be used as a motion vector prediction candidate.

Meanwhile, the encoder can obtain the prediction signal of a target block to be coded using at least one of the aforementioned methods for encoding the target block. That is, the encoder can select an optimal prediction method from an intra-frame prediction method using a reference sample that belongs to the same picture as a target block from a rate-distortion viewpoint, an inter-frame prediction method using a reference picture in the same layer, a method of performing inter-frame prediction using a lower layer, and a method of performing inter-frame prediction on a plurality of reference pictures included in a lower layer and a higher layer and using the weighted sum of predicted values of the reference pictures, code information about the selected method, and send the coded information.

In relation to a target block for which intra-frame prediction is not selected according to a prediction method, information about a selection method can be coded as in Table 1. Table 1 shows a syntax ‘inter_pred_idc’ that informs an inter-frame prediction direction according to a slice type of a higher layer in order to signal a prediction method.

TABLE 1

| Slice type | inter_pred_idc | Prediction method |
|---|---|---|
| EI (I-slice | inferred | Uni-directional prediction using a lower |
| in a higher | | layer picture |
| layer) | | |
| EP (P-slice | 0 | Uni-directional prediction using a forward |
| in a higher | | picture |
| layer) | 3 | Uni-directional prediction using a lower |
| | | layer picture |
| | 4 | Bi-directional prediction using a forward |
| | | picture and a lower layer picture |
| EB (B-slice | 0 | Uni-directional prediction using a forward |
| in a higher | | picture |
| layer) | 1 | Uni-directional prediction using a |
| | | backward picture |
| | 2 | Bi-directional prediction using a forward |
| | | picture and a backward picture |
| | 3 | Uni-directional prediction using a lower |
| | | layer picture |
| | 4 | Bi-directional prediction using a forward |
| | | picture and a lower layer picture |
| | 5 | Bi-directional prediction using a backward |
| | | picture and a lower layer picture |
| | 6 | Multi-directional prediction using a |
| | | forward picture, a backward picture, and a |
| | | lower layer picture |

In Table 1, a number allocated to each prediction method can be varied depending on a probability that the prediction method is generated. A smaller number can be allocated to a prediction method that is frequently generated, and a greater number can be allocated to a prediction method that is small generated.

A method of generating a prediction signal for a target block to be decoded by the decoder is described below.

A method of generating the prediction signal of a target block to be decoded can be differently selected based on information about a prediction method transmitted by the encoder.

In an embodiment, if a method of generating the prediction signal of a target block to be decoded is intra-frame prediction described with reference to FIGS. 4 and 5, the prediction signal can be generated by performing intra-frame prediction based on values of restored samples neighboring the target block.

In this case, the prediction signal can be generated by performing a decoding process in a common intra-frame prediction method. That is, a current block can be restored by adding a residual, received from the encoder, to the prediction signal.

In another embodiment, if a method of generating the prediction signal of a target block to be decoded is the aforementioned inter-frame prediction, the prediction signal can be generated by performing motion compensation with reference to pictures anterior or posterior to a picture that includes the target block to be decoded.

That is, the decoder can generate the prediction signal by performing a decoding process according to a common inter-frame prediction method. The decoder can restore a current block by adding a residual, received from the encoder, to the prediction signal.

In yet another embodiment, if a method of generating the prediction signal of a target block to be decoded uses a reference layer as in FIG. 6, the prediction signal can be generated by performing motion compensation on the restored picture of a layer to which the target block to be decoded refers.

The decoder can decode motion information received from the encoder and generate the prediction signal by performing motion compensation on a restored picture of the reference layer.

When decoding the motion information, the decoder can configure a motion vector prediction candidate using neighboring blocks that neighbor the target block to be decoded, like the encoder. In this case, only the neighboring blocks decoded as the restored picture of the reference layer may be used as prediction candidates. If a block decoded as the restored picture of the reference layer is not present in the neighboring blocks, (0,0) may be used as the motion vector prediction candidate.

The decoder can parse optimal prediction candidate information received from the encoder and obtain the motion vector value MV_I2[x,y] used in motion compensation by adding a prediction value of a selected motion vector and a difference signal of a decoded motion vector.

If an indicator indicating that the same location as that of a target block to be decoded needs to be referred to is received from the encoder, the decoder can infer a motion vector for the restored picture of the reference layer as (0,0) and generate the prediction signal from the restored block of the reference layer that corresponds to the location of the target block to be decoded.

Alternatively, the decoder can generate the prediction signal from a restored block of a reference layer at a location corresponding to a location of the target block to be decoded in accordance with a predetermined rule.

As described above, the decoder can restore a current block by adding a residual, received from the encoder, to the generated prediction signal.

In further yet another embodiment, if a method of generating the prediction signal of a target block to be decoded uses a picture within the same layer and the picture of a reference layer as in FIG. 7, a prediction signal can be generated by performing motion compensation using a reference picture within the same layer and a restored picture of a layer to which the target block to be decoded refers.

The decoder can decode motion information about a reference picture in the same layer, received from the encoder, or an intra-frame prediction mode and motion information about the reference layer and then generate a prediction signal, like the encoder, by performing motion compensation on a reference picture in the same layer or intra-frame prediction from a reference sample included in a neighboring restored block and motion compensation on a reference picture in a reference layer.

Alternatively, the decoder may decode motion information about a reference picture in the same layer, received from the encoder, or an intra-frame prediction mode and then generate a prediction signal, like the encoder, by performing motion compensation on the reference picture or intra-frame prediction from a reference sample included in a neighboring restored block and generating a prediction signal from a restored block in a reference layer that corresponds to a location of a target block to be decoded.

For example, if a slice type of a target block to be decoded is an EP slice of Table 1 and a value of restored information ‘inter_pred_idc’ is 4, the decoder can generate a prediction signal using a forward reference picture and a restored picture in a reference layer.

Here, motion information to be decoded can include motion information about a forward reference picture and reference layer.

Furthermore, the prediction signal Pc[x,y] of the target block to be decoded can be obtained using the weighted sum the prediction signal P0[x,y], obtained through motion compensation from the forward reference picture, and the prediction signal P2[x,y] obtained through motion compensation from a picture in the reference layer.

If an indicator indicating that the same location as that of a target block to be decoded needs to be referred to is received from the encoder, the decoder can infer a motion vector for a restored picture in the reference layer as (0,0) and generate a prediction signal from a block in the reference layer at a location that corresponds a location of the target block to be decoded.

Alternatively, the decoder can generate a prediction signal from a block in the reference layer at a location that corresponds to a location of the target block to be decoded in accordance with a predetermined rule.

The decoder can restore a current block by adding a residual, received from the encoder, to the prediction signal that has been generated as described above.

Table 2 shows an embodiment of a syntax structure for a Coding Unit (CU) in a higher layer, which can be applied to the video encoding and decoding apparatus for encoding and decoding a multiple layer structure according to the present invention.

TABLE 2

Descriptor

coding_unit( x0, y0, log2CbSize ) {

CurrCbAddrTS = MinCbAddrZS[ x0 >>
Log2MinCbSize ][ y0 >> Log2MinCbSize ]
if( transquant_bypass_enable_flag ) {

| | |
|---|---|
| cu_transquant_bypass_flag | ae(v) |

}
if ( adaptive_base_mode_flag | |
default_base_mode_flag | |

(!defaut_base_mode_flag && slice_type != EI ))

| | |
|---|---|
| skip_flag[ x0 ][ y0 ] | ae(v) |

if( skip_flag[ x0 ][ y0 ] )

prediction_unit( x0, y0 , log2CbSize )

else {

if (adaptive_base_mode_flag)

| | |
|---|---|
| base_mode_flag | ae(v) |

if( !base_mode_flag && slice_type != EI )

| | |
|---|---|
| pred_mode_flag | ae(v) |

if( PredMode != MODE_INTRA | | log2CbSize
= = Log2MinCbSize )

| | |
|---|---|
| part_mode | ae(v) |

x1 = x0 + ( ( 1 << log2CbSize ) >> 1 )
y1 = y0 + ( ( 1 << log2CbSize ) >> 1 )
x2 = x1 − ( ( 1 << log2CbSize ) >> 2 )
y2 = y1 − ( ( 1 << log2CbSize ) >> 2 )
x3 = x1 + ( ( 1 << log2CbSize ) >> 2 )
y3 = y1 + ( ( 1 << log2CbSize ) >> 2 )
if( PartMode = = PART_2Nx2N )

prediction_unit( x0, y0 , log2CbSize )

else if( PartMode = = PART_2NxN ) {

prediction_unit( x0, y0 , log2CbSize )
prediction_unit( x0, y1 , log2CbSize )

} else if( PartMode = = PART_Nx2N ) {

prediction_unit( x0, y0 , log2CbSize )
prediction_unit( x1, y0 , log2CbSize )

} else if( PartMode = = PART_2NxnU ) {

prediction_unit( x0, y0 , log2CbSize )
prediction_unit( x0, y2 , log2CbSize )

} else if( PartMode = = PART_2NxnD ) {

prediction_unit( x0, y0 , log2CbSize )
prediction_unit( x0, y3 , log2CbSize )

} else if( PartMode = = PART_nLx2N ) {

prediction_unit( x0, y0 , log2CbSize )
prediction_unit( x2, y0 , log2CbSize )

} else if( PartMode = = PART_nRx2N ) {

prediction_unit( x0, y0 , log2CbSize )
prediction_unit( x3, y0 , log2CbSize )

} else { /* PART_NxN */

prediction_unit( x0, y0 , log2CbSize )
prediction_unit( x1, y0 , log2CbSize )
prediction_unit( x0, y1 , log2CbSize )
prediction_unit( x1, y1 , log2CbSize )

}
if( !pcm_flag )

transform_tree( x0, y0, x0, y0, log2CbSize,
log2CbSize, log2CbSize, 0, 0 )

}

}

Referring to Table 2, adaptive_base_mode_flag can be placed in a Video Parameter Set (VPS), a Sequence Parameter Set (SPS), a Picture Parameter Set (PPS), an Adaptation Parameter Set (APS), and a slice header. If adaptive_base_mode_flag has a value of ‘1’, base_mode_flag can have a value of ‘1’ or ‘0’.

If adaptive_base_mode_flag has a value of ‘0’, a value of base_mode_flag can be determined by a value of default_base_mode_flag.

default_base_mode_flag can be placed in a VPS, an SPS, a PPS, an APS, and a slice header. If default_base_mode_flag has a value of ‘1’, base_mode_flag always has a value of ‘1’. If default_base_mode_flag has a value of ‘0’, base_mode_flag always has a value of ‘0’.

If base_mode_flag has a value of ‘1’, a coding unit can be coded using a reference layer as shown in FIGS. 6 and 7. If base_mode_flag has a value of ‘0’, a coding unit can be coded using common intra-frame prediction using a current layer and an inter-frame prediction method.

Table 3 shows an embodiment of a syntax structure for a Prediction Unit (PU) in a higher layer, which can be applied to the video encoding and decoding apparatus for encoding and decoding a multiple layer structure according to the present invention.

TABLE 3

Descriptor

prediction_unit( x0, y0, log2CbSize ) {

if( skip_flag[ x0 ][ y0 ] ) {

if( MaxNumMergeCand > 1 )

| | |
|---|---|
| merge_idx[ x0 ][ y0 ] | ae(v) |

} else if( base_mode_flag )

if ( slice_type != EI )

| | |
|---|---|
| combined_pred_flag [ x0 ][ y0 ] | ae(v) |

if ( combined_pred_flag [ x0 ][ y0 ] ) {

if( slice_type = = EB )
if( inter_pred_idc[ x0 ][ y0 ] == Pred_LC ) {

if( num_ref_idx_lc_active_minus1 > 0 )

| | |
|---|---|
| ref_idx_lc[ x0 ][ y0 ] | ae(v) |

mvd_coding(mvd_lc[ x0 ][ y0 ][ 0 ],

mvd_lc[ x0 ][ y0 ][ 1 ])

| | |
|---|---|
| mvp_lc_flag[ x0 ][ y0 ] | ae(v) |

} elseif (inter_pred_idc[ x0 ][ y0 ] == Pred_L0 ){

if( num_ref_idx_l0_active_minus1 > 0 )

| | |
|---|---|
| ref_idx_l0[ x0 ][ y0 ] | ae(v) |

mvd_coding(mvd_l1[ x0 ][ y0 ][ 0 ],

| | |
|---|---|
| mvd_l1[ x0 ][ y0 ][ 1 ]) | ae(v) |

mvp_l0_flag[ x0 ][ y0 ]

}

}
if( mv_l2_zero_flag) {

mv_l2[ x0 ][ y0 ][ 0 ] = 0
mv_l2[ x0 ][ y0 ][ 1 ] = 0

} else {

mvd_coding(mvd_l2[ x0 ][ y0 ][ 0 ],

mvd_l2[ x0 ][ y0 ][ 1 ])

| | |
|---|---|
| mvp_l2_flag[ x0 ][ y0 ] | ae(v) |

}

}

} else if( PredMode = = MODE_INTRA ) {

if( PartMode = = PART_2Nx2N && pcm_enabled_flag &&

| | |
|---|---|
| log2CbSize >= Log2MinIPCMCUSize && | |
| log2CbSize <= Log2MaxIPCMCUSize ) | |
| pcm_flag | ae(v) |

if( pcm_flag ) {

| | |
|---|---|
| num_subsequent_pcm | tu(3) |
| NumPCMBlock = num_subsequent_pcm + 1 | |
| while( !byte_aligned( ) ) | |

| | |
|---|---|
| pcm_ alignment_zero_bit | u(v) |

pcm_sample( x0, y0, log2CbSize )

} else {

| | |
|---|---|
| prev_intra_luma_pred_flag[ x0 ][ y0 ] | ae(v) |
| if( prev_intra_luma_pred_flag[ x0 ][ y0 ] ) | |

| | |
|---|---|
| mpm_idx[ x0 ][ y0 ] | ae(v) |

Else

| | |
|---|---|
| rem_intra_luma_pred_mode[ x0 ][ y0 ] | ae(v) |

| | |
|---|---|
| intra_chroma_pred_mode[ x0 ][ y0 ] | ae(v) |
| SignalledAsChromaDC = | |

( chroma_pred_from_luma_enabled_flag ?

intra_chroma_pred_mode[ x0 ][ y0 ] = = 3 :
intra_chroma_pred_mode[ x0 ][ y0 ] = = 2 )

}

} else { /* MODE_INTER */

| | |
|---|---|
| merge_flag[ x0 ][ y0 ] | ae(v) |
| if( merge_flag[ x0 ][ y0 ] ) { | |

if( MaxNumMergeCand > 1 )

| | |
|---|---|
| merge_idx[ x0 ][ y0 ] | ae(v) |

} else {

if( slice_type = = B )

| | |
|---|---|
| inter_pred_flag[ x0 ][ y0 ] | ae(v) |

if( inter_pred_flag[ x0 ][ y0 ] = = Pred_LC ) {

if( num_ref_idx_lc_active_minus1 > 0 )

| | |
|---|---|
| ref_idx_lc[ x0 ][ y0 ] | ae(v) |

mvd_coding(mvd_lc[ x0 ][ y0 ][ 0 ],

mvd_lc[ x0 ][ y0 ][ 1 ])

| | |
|---|---|
| mvp_lc_flag[ x0 ][ y0 ] | ae(v) |

} else { /* Pred_L0 or Pred_BI */

if( num_ref_idx_l0_active_minus1 > 0 )

| | |
|---|---|
| ref_idx_l0[ x0 ][ y0 ] | ae(v) |

mvd_coding(mvd_l0 [ x0 ][ y0 ][ 0 ],

mvd_l0[ x0 ][ y0 ][ 1 ])

| | |
|---|---|
| mvp_l0_flag[ x0 ][ y0 ] | ae(v) |

}
if( inter_pred_flag[ x0 ][ y0 ] = = Pred_BI ) {

if( num_ref_idx_l1_active_minus1 > 0 )

| | |
|---|---|
| ref_idx_l1[ x0 ][ y0 ] | ae(v) |

if( mvd_l1_zero_flag ) {

mvd_l1[ x0 ][ y0 ][ 0 ] = 0
mvd_l1[ x0 ][ y0 ][ 1 ] = 0

} else

mvd_coding( mvd_l1[ x0 ][ y0 ][ 0 ],

mvd_l1[ x0 ][ y0 ][ 1 ] )

| | |
|---|---|
| mvp_l1_flag[ x0 ][ y0 ] | ae(v) |

}

}

Referring to Table 3, assuming that base_mode_flag has a value of ‘1’ within a coding unit, if combined_pred_flag[x0][y0] has a value of ‘1’, a prediction signal for a prediction unit can be generated using a method, such as that of FIG. 7. If combined_pred_flag[x0][y0] has a value of ‘0’, a prediction signal for a prediction unit can be generated using a method, such as that of FIG. 6.

mv_I2_zero_flag can be present in a VPS, an SPS, a PPS, an APS, a slice header, and a coding unit. If mv_I2_zero_flag has a value of ‘1’, the decoder can infer motion information about a restored picture in a reference layer as (0,0) and use the inferred motion information. In this case, no motion information about the restored picture of the reference layer may be transmitted.

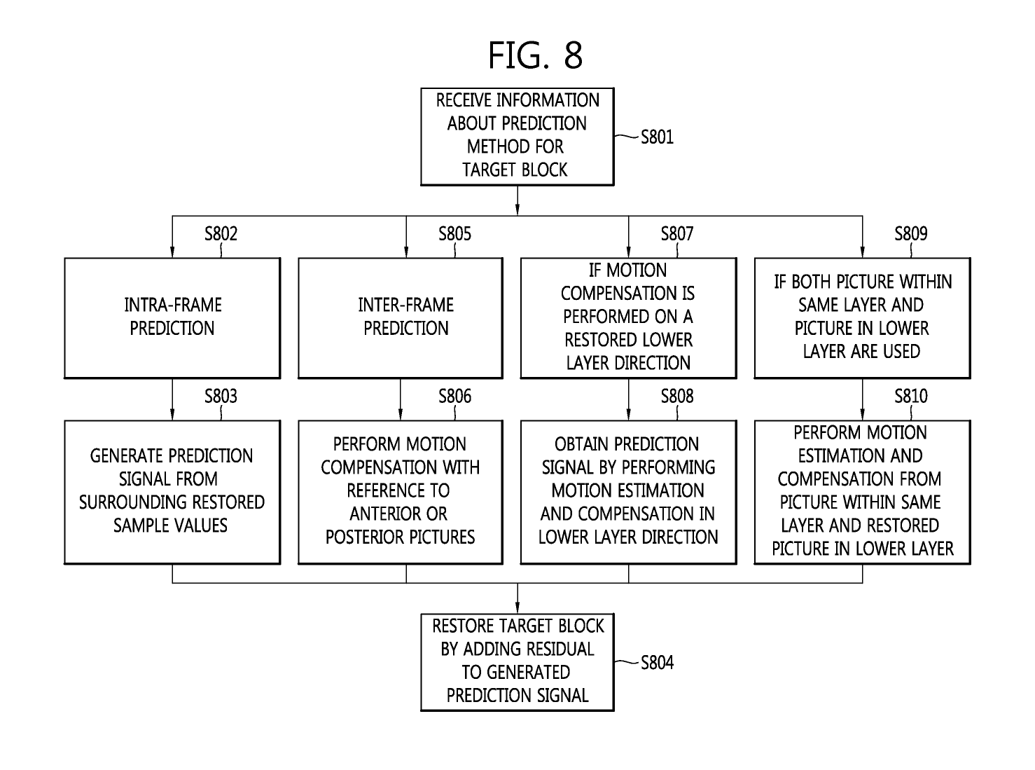

FIG. 8 is a control flowchart illustrating a method of generating the prediction signal of a target block according to the present invention. An example in which the decoder generates a prediction signal and restores a target block is described with reference to FIG. 8, for convenience of description.

The decoder receives information about a prediction method based on Table 2 to 3, regarding that a target block has been predicted using which one of the prediction methods at step S801.

If the prediction method for the target block is intra-frame prediction at step S802, the decoder can generate a prediction signal from surrounding restored sample values that neighbor the target block at step S803.

The decoder can restore the target block by adding a residual, received from the encoder, to the generated prediction signal at step S804.

Meanwhile, if the prediction method for the target block is common inter-frame prediction at step S805, the decoder can generate a prediction signal by performing motion compensation with reference to pictures anterior or posterior to a picture that includes the target block at step S806.

Even in this case, the decoder can restore the target block by adding a residual, received from the encoder, to the generated prediction signal at step S804.

If the prediction method for the target block is a method of performing motion compensation on a reference layer, that is, a restored lower layer, at step S807, the decoder can generate a prediction signal by performing motion compensation in the direction of a lower layer at step S808.

For the motion estimation and compensation, a motion vector, from among pieces of motion information received from the encoder, can be one of motion vectors derived from neighboring blocks that neighbor the target block. Here, the neighboring blocks can include a block decoded as a restored picture in a lower layer.

If the prediction method for the target block uses both a picture within the same layer and a picture in a lower layer at step S809, the decoder can generate a prediction signal by performing motion compensation with reference to a reference picture within the same layer and a restored picture in a layer to which the target block to be decoded refers at step S810.

The prediction signal is added to a residual received from the encoder, which becomes a restored value in the target block at step S804.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

The above-described embodiments include various aspects of examples. Although all kinds of possible combinations for representing the various aspects may not be described, a person having ordinary skill in the art will understand that other possible combinations are possible. Accordingly, the present invention should be construed as including all other replacements, modifications, and changes which fall within the scope of the claims.

1. A video decoding method supporting a plurality of layers, comprising:
receiving information about a prediction method of predicting a target block to be decoded; and
generating a prediction signal of the target block based on the received information,
wherein the information comprises predicting the target block using a restored lower layer.

2. The video decoding method of claim 1, wherein generating the prediction signal comprises performing motion compensation in a direction of the lower layer.

3. The video decoding method of claim 2, wherein the information comprises a motion vector derived through motion estimation performed on a decoded picture of the lower layer in a encoder.

4. The video decoding method of claim 1, wherein generating the prediction signal comprises generating a restored value of a reference block, corresponding to the target block in the lower layer, as the prediction signal.

5. The video decoding method of claim 1, wherein generating the prediction signal comprises performing motion compensation using a reference picture in a layer identical with a layer of the target block and a restored picture in a layer to which the target block refers.

6. The video decoding method of claim 5, wherein generating the prediction signal comprises calculating a weighted sum of a prediction signal obtained from a forward reference picture and a prediction signal obtained from a lower layer reference picture.

7. The video decoding method of claim 5, wherein generating the prediction signal comprises calculating a weighted sum of a prediction signal obtained from a backward reference picture and a prediction signal obtained from a lower layer reference picture.

8. The video decoding method of claim 5, wherein generating the prediction signal comprises calculating a weighted sum of a prediction signal obtained from a forward reference picture, a prediction signal obtained from a backward reference picture, and a prediction signal obtained from a lower layer reference picture.

9. The video decoding method of claim 5, wherein generating the prediction signal comprises calculating a weighted sum of a prediction signal obtained from a reference sample included in a restored neighboring block neighboring the target block and a prediction signal obtained from a lower layer reference picture.

10. The video decoding method of claim 1, wherein the information further comprises information indicative of any one of an intra-frame prediction method, an inter-frame prediction method, a lower layer direction prediction method, and a prediction method using restored reference pictures in an identical layer and a lower layer in relation to the prediction method of prediction the target block.

11. A video decoding apparatus supporting a plurality of layers, comprising:
a reception module configured to receive information about a prediction method of predicting a target block to be decoded; and
a prediction module configured to generate a prediction signal of the target block based on the received information,
wherein the information comprises predicting the target block using a restored lower layer.

12. The video decoding apparatus of claim 11, wherein the prediction module performs motion compensation in a direction of the lower layer.

13. The video decoding apparatus of claim 12, wherein the information comprises a motion vector derived through motion estimation performed on a decoded picture of the lower layer in a encoder.

14. The video decoding apparatus of claim 11, wherein the prediction module generates a restored value of a reference block, corresponding to the target block in the lower layer, as the prediction signal.

15. The video decoding apparatus of claim 11, wherein the prediction module performs motion compensation using a reference picture in a layer identical with a layer of the target block and a restored picture in a layer to which the target block refers.

16. The video decoding apparatus of claim 15, wherein the prediction module calculates a weighted sum of a prediction signal obtained from a forward reference picture and a prediction signal obtained from a lower layer reference picture.

17. The video decoding apparatus of claim 15, wherein the prediction module calculates a weighted sum of a prediction signal obtained from a backward reference picture and a prediction signal obtained from a lower layer reference picture.

18. The video decoding apparatus of claim 15, wherein the prediction module calculates a weighted sum of a prediction signal obtained from a forward reference picture, a prediction signal obtained from a backward reference picture, and a prediction signal obtained from a lower layer reference picture.

19. The video decoding apparatus of claim 15, wherein the prediction module calculates a weighted sum of a prediction signal obtained from a reference sample included in a restored neighboring block neighboring the target block and a prediction signal obtained from a lower layer reference picture.

20. The video decoding apparatus of claim 11, wherein the information further comprises information indicative of any one of an intra-frame prediction method, an inter-frame prediction method, a lower layer direction prediction method, and a prediction method using restored reference pictures in an identical layer and a lower layer in relation to the prediction method of prediction the target block.
